(19) United States
(12) Patent Application Publication
(10) Pub. No.: US 2006/0198766 A1
(43) Pub. Date: Sep. 7, 2006

(54) Docking device for a fluidic microsystem

(75) Inventors: Torsten Muller, Berlin (DE); Stefan Hummel, Haseldorf (DE); Annette Pfennig, Berlin (DE)

Correspondence Address: THE LAW OFFICE OF RANDALL T. ERICKSON, P.C., 425 WEST WESLEY STREET, SUITE 1, WHEATON, IL, 60187, US

(73) Assignee: EVOTREC TECHNOLOGIES GMBH

(21) Appl. No.: 10/556,095

(22) PCT Filed: May 10, 2004
(86) PCT No.: PCT/EP04/04983

§ 371 Date: Apr. 20, 2006

(30) Foreign Application Priority Data
May 9, 2003 (DE) 103 20 957.3

(51) Int. Cl. B01L 9/00

(52) U.S. Cl. 422/104

(57) ABSTRACT

The invention relates to a docking device (100) for retaining a fluidic microsystem (10), comprising a base plate (20) and a retaining frame (30), movable relative to the base plate (20) and used to fasten the microsystem (10) on the base plate (20). The retaining frame (30) is adapted to detachably receive the microsystem (10) and can be detached from the base plate (20) together with the microsystem (10). The device is also provided with a clamping device (40) with which the microsystem (10) on the retaining frame (30) can be pushed against the base plate (20). The invention also relates to methods for operating a fluidic microsystem (10) using said docking device (100).

The invention concerns a docking device for retaining a fluidic microsystem, specifically for the electrical and/or fluidic coupling of a fluidic microsystem to an analysing device, such as a cell sorter. The invention also relates to a process to connect a fluidic microsystem to an analysing device.

The dielectrophoretic manipulation, measurement and sorting of suspended, microscopically small particles in a fluidic microsystem is described in publication “A 3-D microelectrode system for handling and caging single cells and particles” by T. Müller et al. (“Biosensors and Bioelectronics”, volume 14, 1999, page 247-256). The cells are transferred from a sample reservoir to a carrier liquid and they are moved with it through the microsystem. Then, and/or depending on the result of the measurement they are collected in a sample storage. The microsystem is connected, to a fluidics system, which contains additional reservoirs, for example, for flushing liquids, pumps, valves, etc. in addition to the sample reservoir. The microsystem is also connected to a control unit, specifically for producing high-frequency electrical voltages, which are used to charge the electrodes in the microsystem to produce the desired dielectrophoretic force actions.

The adherence to sterile operating conditions and preferably also to GMP conditions is an important requirement for the examination of biological cells. For example, cells sorted according to certain characteristics must be available for further uses or processes after cell sorting. A specific requirement is that sterile operating conditions are available without interruptions during the entire sequence of individual processes.

The disadvantage of conventional applications of fluidic Microsystems is maintaining the sequence of sterile operating conditions only with great effort. The sterility, for example, is jeopardised when the microsystem and possibly also the fluidics system is transferred to an analysing device after filling in a laminar flow cabinet and is there retained to be connected to a control and measuring equipment. The previous fastening device used in the field is based on the fact that the microsystem is bolted between a circuit board adapter and a retaining frame and is then connected to the control unit.

Connecting the microsystem to special fluidic and electrical attachments of the analysing device not only represents a contamination risk, but also a relatively high time requirement, which can present a problem to gentle and quick processing of biological cells.

An additional disadvantage of conventional applications of fluidic Microsystems consists in the fact that measuring set-ups are frequently constructed of numerous confusingly and uncontrollably distributed components. This complicates the operation and undesirable interferences may develop.

The invention is based on the problem of providing a docking device for retaining a fluidic microsystem, specifically in an analysing device such as a cell sorter, with which the problems of conventional techniques can be overcome. The docking device should specifically enable quick and easy coupling of the fluidic microsystem to the analysing device without interrupting sterile conditions. The invention is also based on the problem of providing improved processes to use fluidic Microsystems with which the problems of conventional techniques are overcome.

These problems are solved by docking devices and processes with the characteristics according to claims 1 or 18.

Advantageous embodiments and applications of the invention result from the related claims.

With respect to a device, the invention is based on the general technical principle of further developing a docking device with a base plate and a retaining frame which is preferably movable, whereby the retaining frame forms a component on which the microsystem can be located on the one hand, and can be separated from the base plate on the other hand and is movable specifically in combination with the microsystem, and that a device is specifically provided to located the retaining frame, with which the combination of the retaining frame and the microsystem can be positioned on the base plate. This specifically designates a clamping device.

These characteristics advantageously allow the microsystem to be prepared under sterile conditions, for example, such as filled initially in combination with the retaining frame prior to analysis. The microsystem can then be connected reproducibly and stably to the base plate by activating the clamping device, without contact with a tool, or manually by positioning the retaining frame on the base plate. The base plate with the clamping device is preferably a stationary part of an analysing device, such as a cell sorter. The microsystem is advantageously fitted and aligned in the analysing device after activating the clamping device and immediately available for subsequent operation sequences.

The clamping device allows adjustment of a particular adjustable and tunable contact pressure of the retaining frame and the microsystem against the base plate. Another important advantage of the docking device of the invention, specifically for optical measurements on the microsystem, is the fact that the microsystem is held on the base plate without overturning.

According to a preferred embodiment of the invention provision is made for a retaining frame being solidly connected to the fluidics system. The retaining frame is equipped with a firmly fixed fluidics carrier. The fluidics carrier, for example, is a plate-shaped fastening device for partial or full mounting of the fluidics system, for example, which contains spray applicators, reservoirs, pumps, injectors, valves, hoses and the like for the fluidic supply and control of the microsystem. The fluidics system can be positioned on the fluidics carrier or arranged to be completely or partially reversibly exchangeable. The solid connection of the fluidics carrier with the retaining frame simplifies the fluidic coupling of the microsystem. Special advantages can result when the fluidics system is arranged completely or partially solidly on the fluidics carrier. The retaining frame and the fluidics carrier form a connection in this case, which can be completely disconnected from the base plate. This version represents a considerable advantage as opposed to conventional analysing devices, since the fluidics system and the microsystem can be completely filled and prepared under sterile conditions, for example, in a laminar flow cabinet, prior to their being used as an independent module in the analysing device. The fluidics carrier is positioned on the base plate with the fluidics system and the microsystem after activating the clamping device and desired analysis can begin immediately.

A special advantage of the connection of the retaining frames with the fluidics carrier is the fact that a compact structure is produced with short distances between the fluidics system and the microsystem. Relatively short fluidic lines can be used between the fluidics system and the microsystem, so that the risk of an undesirable entry of mechanical vibrations is reduced. A complete and portable module is formed by the combination of the fluidics system and the microsystem.

The flexibility of the application of the docking device also represents an important advantage. The combination of the fluidics carrier and the fluidics system and the retaining frame is not only adjusted for the coupling of the sorting system described below, but is also adapted to other microsystems with other tasks.

Another preferred embodiment of the invention provides that the clamping device contains a connection plate, which is attached by at least one tension spring on the base plate and contains an eccentric lever, with which the connection plate can be lifted from the base plate against the effect of at least one tension spring. Considerable holding power can be achieved advantageously with this embodiment, if the retaining frame and/or the fluidics carrier is positioned between the connection plate and the base plate. The connection plate preferably also fulfils the function of a lateral guide, so that alignment of the retaining frame and/or the fluidics carrier on the base plate is simplified.

The clamping device also has a stop for relatively complete, accurate and quick alignment of the retaining frame and/or the fluidics carrier to the base plate according to a version of the invention.

The potential of an optional clamping device, which does not require a lever and a tension spring, also exists. A pressure-tension pneumatic cylinder may be used here for lowering and later releasing operations. It is desirable for this embodiment (however, this may also be used for other embodiments) that fitted recesses are provided on the bottom of the microsystem, for example, which are precisely gripped by guide pins attached to the base plate. This improves the positioning accuracy.

The clamping device can also operate with magnets.

If a tensioning device is provided under an optional embodiment of the invention, which produces a prestressing force between the retaining frame and the base plate, it may be advantageous for inserting and removing the retaining frame. The retaining frame and possibly the fluidics carrier, for example, are arranged to swivel towards the base plate according to a version of the invention, so that the retaining frame and the fluidics carrier perform a movement under the effect of the prestressing force when the tensioning device is released and therefore releases the retaining frame of the combination consisting of the retaining frame and the fluidics carrier for easy access.

Special advantages result when electrical contacts are provided on the surface of the base plate, via which the fluidic microsystem can be connected to a control and/or measuring device (including power supply). The retaining frame can be pressed against the bottom with the clamping device in this case, so that the electrode contacts of the fluidic microsystem are connected to the electrical contacts of the base plate.

Connection between the electrode contacts of the microsystem and the contacts of the base plate can be formed by conventional plug-socket combinations. Special advantages for quick coupling of the microsystem, however, result when the contacts on the base plate have a contact layer with electrically conductive contact points, which produce the desired electrical connections. A development, in which the contact layer contains a flexible plastic material, in which the electrically conductive contact points are formed, is especially preferred. The flexible plastic material is pressed together advantageously when activating the clamping device, so that precise electrical contact is achieved without risking the mechanics of the microsystem.

If the retaining frame is equipped with at least one groove or at least one retaining spring according to another preferred embodiment of the invention, advantages for quickly and solidly positioning the microsystem on the retaining frame may result. The positioning can preferably be completed reproducibly and reversibly without requiring any additional tools. The minimum of one groove or retaining spring allows even load transfer from the retaining frame to the microsystem, so that any stress to the microsystem is prevented.

The invention can generally be applied according to conventional operational fluidics microsystems, specifically in manipulation, dimensioning, processing or sorting of biological particles, such as biological cells, cell groups, cell parts or biologically relevant macromolecules. It is especially preferred, if a cell sorter which sorts biological cells according to certain characteristics, is combined with the docking device. Optional applications are especially possible for exclusively electrical or exclusively fluidic controlled microsystems, where related coupling with the fluidics carrier or with the electrical contacts may then be relinquished. For example, manipulation having the effect of electroosmosis or by magnetic fields is produced in electrically controlled microsystems. However, in fluidically controlled microsystems, cells are manipulated hydrodynamically in flows with valves and pumps.

The above problem of the invention, however, is solved in reference to the process wherein a fluidic microsystem is connected to the docking device with an analysing device, such as a cell sorter according to the invention. A preferred embodiment of the invention provides that the microsystem is initially prepared and especially filled under sterile conditions and is then connected to the analysing device with the docking device. It is especially advantageous for the adherence of a closed sterility chain, if the preparation of the microsystem occurs in combination with a connected fluidics system under sterile conditions.

The docking device of the invention can be a part of a biotechnical device, such as a cell sorter. However, the potential also exists whereby the docking device according to the invention is connected to a filling or flushing device with which the fluidic microsystem can be flushed or filled.

Such a filling device preferably has a flushing agent source to flush the microsystem with a flushing agent (such as a flushing solution), in which the source of the flushing agent is connected to the docking device for a fluidic contact with the microsystem. The fluidic microsystem can be easily flushed by this method and the source of the flushing agent preferably has a compressed gas source, such as a compressed air tank, so that compressed air is used as a flushing agent.

However, the compressed air can also be used as a propellant to propel a liquid flushing solution through the microsystem.

The filling device also preferably has a carrier flow source to fill the microsystem with a carrier liquid and the carrier flow source is connected to the docking device for fluidic contact of the microsystem, so that the carrier liquid can easily be introduced into the fluidic microsystem.

The filling device preferably has a peristaltic pump to transport the carrier liquid and to pump it into the fluidic microsystem.

Additionally, it should be mentioned that the filling device is preferably portable, in order to be able to position the filling device in a so-called laminar flow cabinet with a sterile atmosphere.

The abovedescribed filling device according to the invention advantageously allows preparation of the fluidic microsystem by flushing the microsystem and filling it with carrier liquid. The sorting process can be initiated immediately after docking the fluidic microsystem on the cell sorter without requiring any additional preparatory actions.

Other advantageous further developments of the invention are explained in detail in the following figures with the description of the preferred embodiments of the invention, in which:

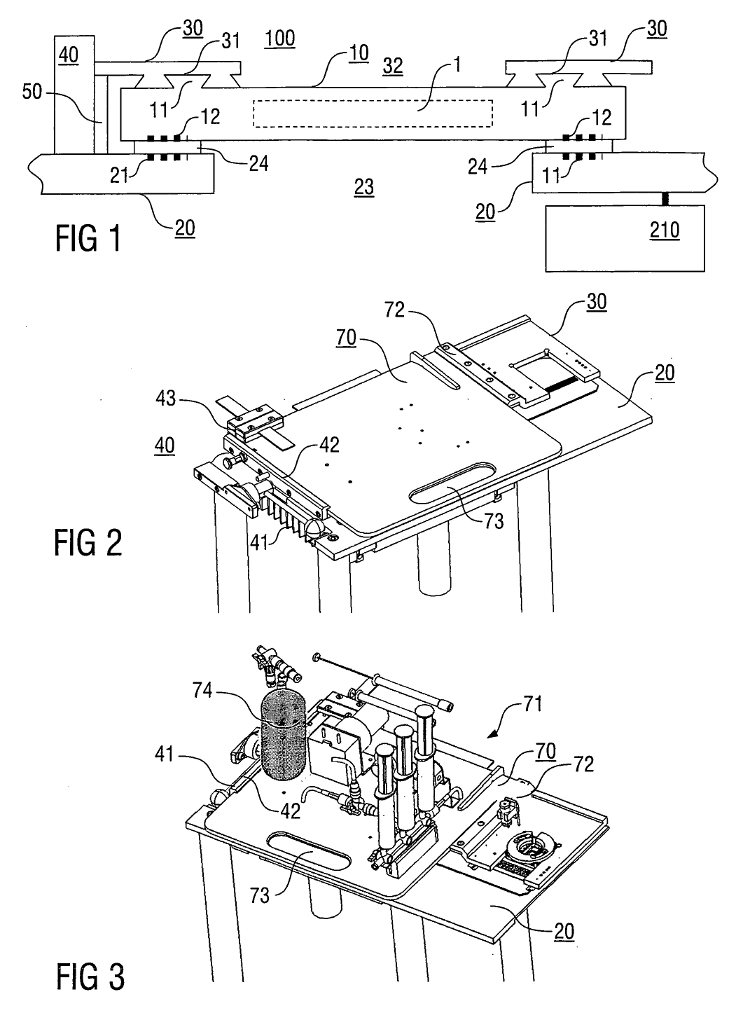

FIG. 1 shows a schematic sectional view of essential parts of a first embodiment of the docking device according to the invention,

FIGS. 2 and 3 show schematic perspective views of another embodiment of the docking device according to the invention,

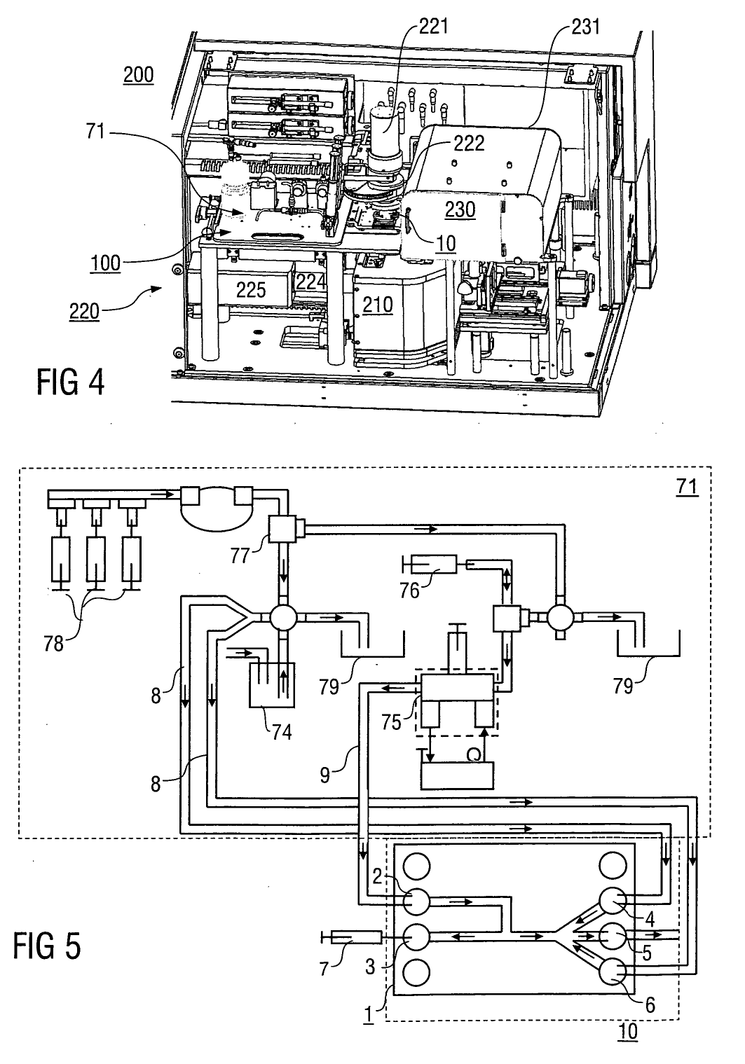

FIG. 4 shows a perspective view of a cell sorter, which is equipped with a docking device according to FIGS. 2 and 3,

FIG. 5 shows an summary presentation of components provided in the cell sorter according to FIG. 4, and

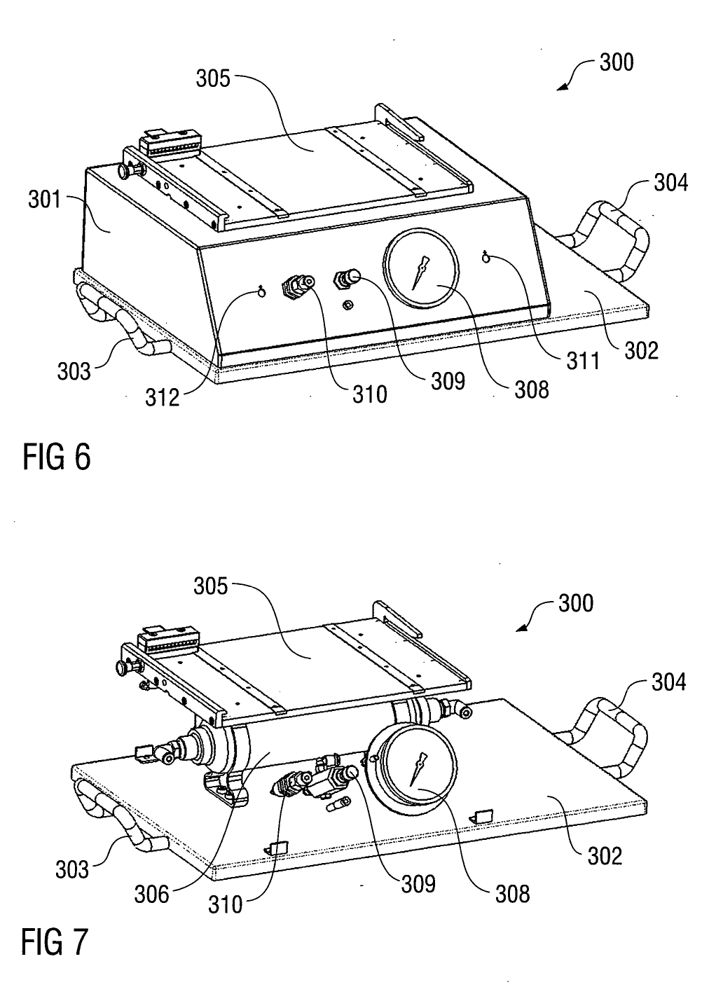

FIGS. 6 to 9 show various perspective illustrations of a so-called off-instrument dock to flush and fill the fluidic microsystem.

The schematic, enlarged sectional view illustrated in FIG. 1 shows a first embodiment of the docking device 100 according to the invention, in which the microsystem 10 is positioned on the base plate 20 in combination with the retaining frame 30 with clamping device 40. The related components are also shown with additional details in another embodiment of the invention in FIGS. 2 and 3. It is stressed that the details shown in FIGS. 1 to 3 may be provided in both embodiments of the docking devices of the invention.

The sectionally displayed base plate 20 is stationary and connected to the related analysing device to which the microsystem 10 must be connected. An examining table, for example, is provided, whose plate forms the base plate 20. A window 23 is provided in the base plate 20, which allows optical measurements or manipulations in the microsystem 10. The base plate 20 also has contacts 21, which are integrated in the base plate 20 attached to the surface of the base plate 20 as circuit board adapter. The contacts are connected electrically to a schematically displayed control and/or measuring unit 210, which is a part of the analysing device.

The retaining frame 30 is a plate-shaped, solid component, which is removable and anchored to the base plate 20. For example, it is anchored directly to the base plate 20 or indirectly via the clamping device 40. The retaining frame 30 has a window 32 for optical measurements or manipulations in the microsystem 10. Grooves 31 are provided on the bottom of the retaining frame 30 parallel to the edge of the window 32, which form a receptacle for the microsystem 10. Retaining springs can be provided as an option to mount the microsystem instead of the grooves 31.

The microsystem 10 is structured as is known from fluidic microsystem technology. It specifically contains a sorting chip 1 (shown in dashes), which, for example, is structured as described in the abovementioned publication by T. Müller et al. The explanation of FIG. 5 (see below) and the mentioned publications are pointed out with respect to the details and the function of the sorting chip 1.

Two holding bars 11 are located on the top of the microsystem 10 of the illustrated embodiment of the invention, which interact with the grooves 31 of the retaining frame 30. If the microsystem is mounted with retaining springs, the holding bars 11 are not required.

In this event, proper parts of the microsystem, e.g. lateral brackets, are clamped behind the retaining springs on the sorting chip.

Electrode contacts 12 for the electrical connection of the electrodes in the sorting chip 1 are located on the bottom of the microsystem 10. The electrode contacts 12 are integrated into the body of the microsystem 10 or formed on a circuit board, which is connected to the sorting chip 1.

The retaining frame 30 with the microsystem 10 can be pressed against the base plate 20 with the clamping device 40 so that the microsystem 10 is permanently clamped between the retaining frame 30 and the base plate 20 where it is positioned. The electrical contact of the sorting chip occurs via the electrode contacts 12 and the connecting contacts in this condition. The clamping device 40, which is permanently connected to the base plate, can be formed by any suitable clamping mechanism. However, it is preferred if the clamping device 40 has a connection plate, which is connected to the base plate 20 by a tension spring, as well as an eccentric lever, with which the connection plate can be lifted to mount an edge of the retaining frame (see FIGS. 2, 3).

The optionally provided tensioning device 50 is equipped to press the retaining frame 30 against the base plate 20 against an additional pretensioning force. The tensioning device 50, for example, contains a spring mechanism, which initiates the retaining frame 30 to lift from the base plate 20 when releasing the clamping device 40 and therefore simplifies removal of the retaining frame 30 with the microsystem 10.

A contact layer 24 is provided on the base plate 20 above the electrical connecting contacts 21, which contains electrically conductive contact points. The individual connecting contacts 21 are connected to the electrode contacts via the electrically conductive connecting contacts. The contact layer 24 consists of a flexible plastic material, such as silicone rubber into which metal filaments, for example, of gold are embedded as electrical conductors. The contact layer 24 advantageously forms a flexible layer for a voltage-free position of the microsystem 10 on the base plate 20.

Contact springs are alternatively provided on the base plate 20 above the electrical contacts 21 for electrical connection of the microsystem.

The control and/or measuring device 210 contains the conventional components required for the electrical control of the sorting chip 1 and/or for measurements in the sorting chip 1, such as a generator to provide the control voltages, an impedance measuring instrument and/or a measuring device which is connected to a sensor (such as a temperature or pH sensor) in the sorting chip 1. The control and or measuring instrument 210 can also be connected to optical measuring equipment (not illustrated).

A modified embodiment of the docking device according to the invention is illustrated in FIGS. 2 and 3, which is especially advantageous due to the practical module structure of the parts of the retaining frame 30 (with the microsystem 10) and the fluidics carrier 70 (with the fluidics system 71).

FIG. 2 shows the base plate 20 as part of the examining table in the analysing device. The retaining frame 30 is permanently connected to the plate-shaped fluidics carrier 70 by a lateral outrigger 72. The clamping device 40 contains a guide 42 which acts as a connection plate, which is pulled against the base plate 20 under the effect of a tension spring (not illustrated). No tensioning device is provided in this case. The guide 42 can be manually lifted from the base plate 20 with a manually operated eccentric lever 41 so that an adequately wide gap is formed to clamp the edge of the fluid carrier 70.

A stop 43 is also located on one side of the base plate 20. The fluidics carrier 70 can be aligned advantageously and precisely on the base plate 20 with the retaining frame and the microsystem by the interaction of the stop 43 with the guide 42.

FIG. 2 shows the retaining frame 30 and the fluidics carrier 70 for reasons of clarity without the microsystem and without fluidics system. Lever 41 is set in the illustrated condition so that the guide 42 is pulled toward the level of the base plate 20. The retaining frame 30 and the fluidics carrier 70 are clamped onto the base plate 20 accordingly. When the lever 41 is turned over, the gap formed by the guide 42 is enlarged so that the retaining frame 30 and the fluidics carrier 70 can be removed upward from the base plate 20. The combination of both parts, for example, can be pulled out of the analysing device in this condition by pulling the handle 73 of the fluidic carrier 70. FIG. 3 shows the related structure with the inserted microsystem 10 and parts of the fluidics system 71.

FIG. 4 illustrates the integration of the docking device 100 of the invention in a cell sorter 200. The cell sorter 200 is housed in a housing, which is made at least partially of plastic and has a transparent cover to allow a visual check of the operation of the cell sorter. A structure with the docking device 100 of the invention (or: docking station) is located in the housing, as well as the control and/or measuring instrument 210, an optical measuring device 220 and a sample storage device 230. The optical measuring device 220 specifically contains a scanning device 221 for transmitted light analyses, an optical system 222, a camera 223 and a triggering light source 224 for fluorescence measurements. The sample storage device 230 contains a microtiter plate as sample storage in an incubator 231.

The docking device 100 with the microsystem 10 and the fluidics system 71 contain the components illustrated in FIG. 5.

The microsystem 10 contains the sorting chip 1 with several connections 2 to 6 for fluid contacting. The fluidic contacting of the sorting chip 1, for example, is described in PCT/EP03/03092, whose content may be ascribed to the present description. The connection 2 of the sorting chip 1 serves to mount a carrier flow with the biological cells, which must be sorted, while the connection 3 of the sorting chip serves to discard selected cells, which are not analysed further on the sorting chip 1. The selected cells may be collected by a vacuum syringe 7 at the connection 3. The connection 5 of the sorting chip 1, however, serves to discharge the biological cells of interest, which are subsequently further processed or analysed. Connections 4 and 6 further serve to supply a sheathing flow that has the task to guide the selected cells to the connection 5. The German patent application DE 100 05 735 should be pointed out with respect to the function of the sheathing flow.

The fluidics system 71 contains the essential components for the fluidic control and supply and disposal of the microsystem 10. The connections 4 and 6 of the sorting chip 1 are connected to a pressure tank 74 by two sheathing flow lines 8, a Y-section and a 4-way valve, in which a cultivating medium is located for the sheathing flow or a so-called manipulation buffer. The pressure tank 74 is set at excess pressure by a compressed air line so that the cultivating medium located in the pressure tank 74 flows over the Y-section and the sheathing flow lines 8 to the connections, 4, 6 of the sorting chip 1 at an appropriate setting of the 4-way valve.

The connection 2 of the sorting chip 1 is connected to a particle injector 75 via a carrier flow line 9. The particle injector 15 is equipped with a temperature sensor and a tempering element in the form of a Peltier element. Upstream, the particle injector 75 is connected via a T-section to the carrier flow injector, which is powered mechanically and injects a specific liquid flow of a carrier flow. The T-section is also connected upstream with a 3-way valve 77 via an additional 4-way valve and a filling flow line. The 3-way valve 77 promotes flushing the sheathing flow line 8 as well as the carrier flow line 9 prior to the actual operation. The 3-way valve 77 is connected to the three 3-way valves upstream via a peristaltic pump, to each of which an injection reservoir 78 is connected. The injection reservoirs 78 supply the filling flow to flush the entire fluidics system prior to the actual operation.

The fluidics system 71 finally has a collecting tank 79 for excess sheathing flow or for excess filling flow.

The process according to the invention is characterised in that the microsystem 10 can be at least completely removed from the analysing device 200 and cleaned and filled, however, preferably from the combination of the microsystem 10 and the fluidics system 71 (according to FIG. 5). The lines on the connections 2 to 6 are connected under sterile conditions. Only the line on connection 5, which leads to the sample storage device 230, initially has a free end during the preparation. The sterility of this line is guaranteed by a foil cover, which is not removed until after the completing the analysing device 200 with the docking device 100 and the alignment of the line in the sample storage device 230. The fluidics carrier and the retaining frame are combined in the analysing device 200 after preparing the complete module. Only connections, which are not critical for sterility, are made, such as starting the compressed air line in the compressed air tank 74 or an electrical connection of the fluidics system. The desired analysis can then begin immediately.

The perspective illustrations in FIGS. 6 to 9 show a so-called off-instrument dock (OID) 300, which can be used to flush and fill the fluidics microsystem 10 prior to connecting the fluidics microsystem 10 to the cell sorter 200 with the docking device 100.

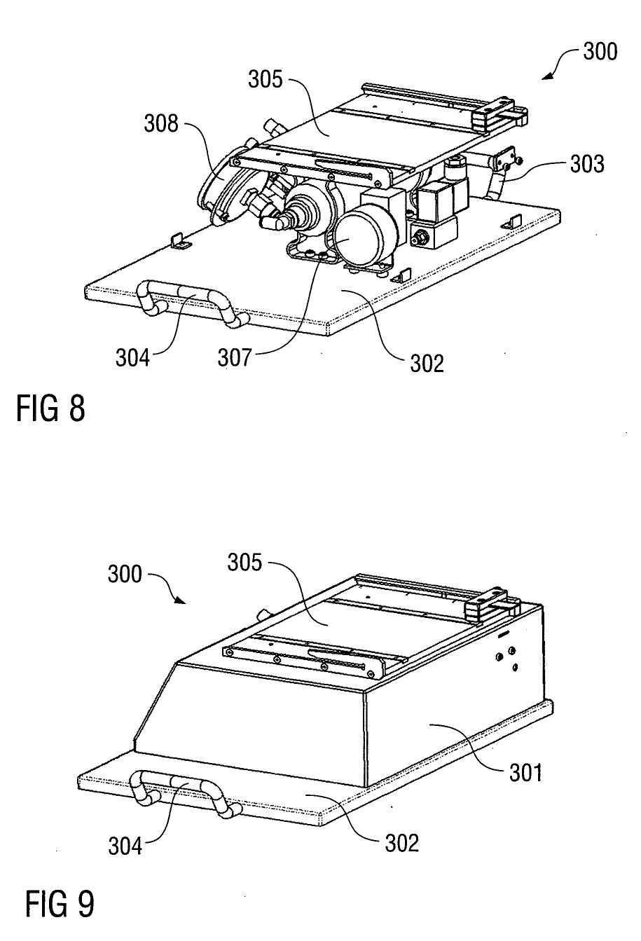

FIGS. 6 and 9 show the off-instrument dock 300 with an attached housing cover 301, while FIGS. 7 and 8 show the off-instrument dock 300 with a removed housing cover 301.

The off-instrument dock 300 is constructed on a rectangular base plate 302 on which two carrier handles 303, 304 are attached on both opposing front sides of the base plate 302. The off-instrument dock 300 is also portable and can be used as a so-called laminar flow box, which has a sterile atmosphere inside. This allows filling the fluidics microsystem 10 under sterile conditions.

The off-instruments dock 300 has a docking device 305 at its top, into which the retaining frame 30 can be placed with the arranged fluidics microsystem 10. The structure and the function of the docking device 305 essentially corresponds with the structure and the function of the docking device 100 of the cell sorter, so that a detailed description of the docking device 305 can be relinquished in the following and the previous description of the docking device 100 can be referred to instead.

The off-instrument dock 300 promotes flushing the fluidics microsystem 10 with compressed air. The off-instrument dock 300 has a compressed air tank 306 for this, which is filled by a compressor 307. The compressed air tank 306 is connected fluidically with the microsystem 10 by the docking device 305, so that compressed air can be blown into the microsystem 10 from the compressed air tank 306, in order to flush it with compressed air.

Further, the off-instrument dock 300 has a compressed air display 308, a control button 309 for the compressed air, a compressed air connection 310 and an on and off switch 311 for the compressor 307 at its front.

The off-instrument dock 300 can also fill the microsystem 10 with a carrier liquid. The off-instrument dock 300 has a peristaltic pump for this purpose, which can be switched on or off by an on/off switch 312 at the front of the housing cover 301.

The invention is not limited to the previously described preferred embodiments. A multitude of versions and derivations is possible, which also made use of the idea of the invention and therefore are included in the safety zone.

1. A docking device for retaining a fluidics micro-system having
a base plate,
a retaining frame, which is preferably movable relatively to the base plate, with which the microsystem can be positioned on the base plate,
whereby the retaining frame is adapted for detachable retaining the microsystem and can be removed from the base plate in combination with the microsystem, and
a device for locating the retaining frame, specifically a clamping device, with which the microsystem can be pressed against the base plate at the retaining frame,
whereby the microsystem can be coupled fluidically to an analysing device via the docking device,
wherein the microsystem can also be coupled electrically to the analysing device.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

23. The docking device as claimed in claim 1, wherein the retaining frame is permanently connected to a fluidics carrier and the combination of the retaining frame and the fluidics carrier is removable from the base plate.

24. The docking device as claimed in claim 23, wherein a fluidics system is arranged permanently on the fluidics carrier.

25. The docking device as claimed in claim 23, wherein a fluidics system is arranged reversibly on the fluidics carrier.

26. The docking device as claimed in claim 1, wherein a connection plate, which is attached to the base plate with at least one tension spring and contains an eccentric lever, can be lifted from the base plate with the connection plate against the force of at least one tension spring, whereas the retaining frame and the fluidics carrier can be positioned between the connection plate and the base plate.

27. The docking device as claimed in claim 1, wherein the clamping device has a stop to adjust the retaining frame and the fluidics carrier relative to the base plate.

28. The docking device as claimed in claim 1, wherein a tensioning device to produce a flexible pre-tensioning force is provided, whereby the retaining frame and the fluidics carrier can be pressed against the base plate with the clamping device against the effect of the pre-tensioning force.

29. The docking device as claimed in claim 28, wherein the retaining frame and the fluidics carrier are arranged movable relatively to the base plate, whereby the retaining frame and the fluidics carrier can be moved away from the base plate under the effects of the pre-tensioning force at a release of the tensioning device.

30. The docking device as claimed in claim 1, at which the base plate has electrical connecting contacts to connect the fluidics microsystem to a control instrument.

31. The docking device as claimed in claim 1, at which the base plate has electrical connecting contacts to connect the fluidics microsystem to a measuring instrument.

32. The docking device as claimed in claim 31, wherein a contact layer with electrically conductive contact points is formed on the electrical connecting contacts.

33. The docking device as claimed in claim 31, wherein electrically conductive contact springs are located on the electrical connecting contacts.

34. The docking device as claimed in claim 33, wherein the contact layer contains a flexible plastic material, in which the electrically conductive contact points are formed by embedded electrical conductors.

35. The docking device as claimed in claim 1, wherein the retaining frame is equipped with at least one groove to anchor the microsystem.

36. The docking device as claimed in claim 1, wherein the retaining frame is equipped with at least one retaining spring to anchor the microsystem.

37. A biotechnical device, with a docking device according to claim 1.

38. The biotechnical device as claimed in claim 37, comprising a flushing agent source for flushing the microsystem with a flushing agent, in which the source of the flushing agent is connected to the docking device for the fluidic contacting of the microsystem.

39. The biotechnical device as claimed in claim 38, wherein the source of the flushing agent has a compressed gas source.

40. The biotechnical device as claimed in claim 37, characterised by a carrier flow source to fill the microsystem with a carrier liquid, in which the carrier flow source is connected to the docking device for the fluidic contacting of the microsystem.

41. The biotechnical device as claimed in claim 40, wherein the carrier flow source has a peristaltic pump.

42. The biotechnical device as claimed in claim 37, wherein the device is portable.

43. A process for operating a fluidic microsystem, wherein the fluidic microsystem is connected to a biotechnical device by a docking device as claimed in claim 1.

44. The process as claimed in claim 43, wherein the fluidics microsystem is filled under sterile conditions and GMP conditions (Good Manufacturing Practice) with the retaining frame and is then connected to the analysing device with the docking device.

45. The process as claimed in claim 44, wherein the fluidics microsystem and a connected fluidics system together with the retaining frame are filled under sterile conditions and are then connected to the analysing device with the docking device.

46. The process as claimed in claim 43, characterised by the following steps:
docking the fluidic microsystem to a docking device of a filling device,
flushing the microsystem with a flushing agent in the filling device,
filling the microsystem with a carrier liquid in the filling device,
removing the microsystem from the filling device,
docking the microsystem on a cell sorter.
